(19) United States
(12) Patent Application Publication
(10) Pub. No.: US 2008/0209145 A1
(43) Pub. Date: Aug. 28, 2008

(54) Techniques for asynchronous data replication

(76) Inventors: Shyamsundar Ranganathan, Bangalore (IN); Kalidas Balakrishnan, Chennai (IN)

Correspondence Address: SCHWEGMAN, LUNDBERG & WOESSNER/NOVELL, PO BOX 2938, MINNEAPOLIS, MN, 55402, US

(21) Appl. No.: 11/888,746

(22) Filed: Aug. 2, 2007

(30) Foreign Application Priority Data
Feb. 27, 2007 (IN) 418/DEL/2007

(51) Int. Cl. G06F 12/16

(52) U.S. Cl. 711/162; 711/E12.103

(57) ABSTRACT

Techniques for asynchronous data replication are presented. A bitmap records changes to selective blocks of data on a source between replication periods. During a replication, the bitmap is copied and used to acquire changed blocks from the source to write to a replica. Should a unprocessed block have a pending write detected during the replication, then that block is copied into cache from the source before the write is processed on the source. The pending write then processes against the source; the copied block is flushed to the replica; the original bitmap and copied bitmap are updated.

### RELATED APPLICATIONS

The present application claims priority to India Patent Application No. 418/DEL/2007 filed in the India Patent Office on Feb. 27, 2007 and entitled “TECHNIQUES FOR ASYNCHRONOUS DATA REPLICATION;” the disclosure of which is incorporated by reference herein.

### FIELD

The invention relates generally to data processing and more particularly to techniques for asynchronous data replication.

### BACKGROUND

Data has become an extremely important asset of enterprises. Consequently, an enterprise's data is regularly backed up or check pointed to ensure that it can be recovered back to some manageable point in time in the event of an unexpected failure. Enterprise data is also regularly replicated to duplicate storage volumes. These techniques and others provide for data check pointing and for data replication in the event that a primary site becomes unavailable.

A snapshot captures all the data in the environment as a copy at a particular point in time (time-based duplication). This can substantially increase storage requirements as more snapshots are taken and not discarded. A replica attempts to maintain the state of a source volume on an external volume, such that should a failure occur users can be switched from the source volume to the external volume with minimal disruption. Each technique (snapshot and replication) has its independent benefits, such that most prudent enterprises deploy both techniques.

Data replication can be implemented in two manners. A first technique is referred to as synchronous replication. Here, each operation occurring on a source is flushed and replicated to a replica in real-time or near real-time. This technique can be performance prohibitive for some enterprises or for some users of the enterprises, since the processing throughput to manage synchronous replication can be costly and noticeable to the users. The second technique is referred to as asynchronous replication.

With asynchronous replication, a replication of the source occurs at configurable intervals. Here, data changes, which occur in the source between intervals, are noted, such that when a new replication interval is detected the changes are processed to the replica. On the surface it would appear to the untrained observer that the asynchronous approach is more performance friendly than synchronous replication.

However, one complication with asynchronous replication is that in order to keep the source environment up and running during a replication interval, the replication has to operate off of a snapshot taken at the start of the replication interval. This is so, because if the asynchronous replication takes place off the source, then a portion of the data that is being replicated from the source during the replication interval may be changed again before it has a chance to be replicated. So, the replica would not reflect the state of the source at the time of the request because it would include the changed portion and that change took place after the replication interval. To solve this, enterprises have mingled and utilized the snapshot and its storage environment.

The solution commonly used is for a snapshot to be taken at a start of a replication interval to preserve the state of the source at the time the replication interval starts. The replication then works from the snapshot and from the source environment. If data has no new changes since the start of the replication interval, then it can be copied from the source to the replica. However, if changes are noted, then it is copied from the snapshot to the replica. The snapshot also includes changes occurring in the source during the replication. This increases the Input/Output (I/O) substantially during an asynchronous replication interval and degrades performance.

Using a snapshot to manage replication is not an optimal solution because a snapshot itself is a complete copy of the source and it takes time to produce, so there are storage and processing impacts by using the snapshot. Second, changes are managed in the snapshot further occupying space, increasing I/O, and doing something that snapshots were not intended to do and that is manage dynamic changes to the source.

Thus, it is advantageous to provide improved techniques for asynchronous data replication, which do not require using a snapshot.

### SUMMARY

In various embodiments, techniques for asynchronous data replication are provided. More specifically, and in an embodiment, a method for performing an asynchronous data replication is presented. An asynchronous replication request is detected. An original bitmap is copied to a new bitmap; the new bitmap identifies changes made to blocks of data since a last successful replication. The new bitmap includes a reference to storage having the blocks of data changed. The original bitmap is cleared and a cache in memory of a machine is created. Next, a write request from an application is handled while processing the asynchronous replication request; the write request further requests modification to a particular block of data being replicated and identified in the new bitmap. A copy of the particular block is acquired into the cache from the storage and acquired before the write request is processed on it in the storage. Finally, the copy of the particular block is replicated from the cache to replication storage and the new bitmap is updated to show the particular block has been successfully replicated.

### BRIEF DESCRIPTION OF THE DRAWINGS

FIG. 1 is a diagram of a method for asynchronous data replication, according to an example embodiment.

FIG. 2 is a diagram of another method for asynchronous data replication, according to an example embodiment.

FIG. 3 is a diagram of asynchronous replication system, according to an example embodiment.

FIG. 4 is a diagram of another asynchronous replication system, according to an example embodiment.

### DETAILED DESCRIPTION

As used herein a “source disk,” a “source,” and a “primary source disk” may be used interchangeably to refer to storage, a volume, or an environment from which data is being replicated. Similarly, a “replica” or a “replica disk” may be used interchangeably to refer to storage, a volume, or an environment to which data is being replicated. Data is replicated from the source to the replica. Replication takes place using an asynchronous replication technique.

A “bitmap” is a data structure that includes a bit for each block of data in the source. When changes occur after a replication, the bitmap is reset (each bit set to zero or false). When a block is changed, its corresponding bit in the bitmap is set true or on.

A “cache” is a data structure or area in memory or in a disk that provides quick access to data. The cache can be created on demand or may be pre-existing and used as needed. A variety of cache tools may be used with the cache, such as flushing, etc.

Various embodiments of this invention can be implemented in existing network architectures, directory services, security systems, and/or communication devices. For example, in some embodiments, the techniques presented herein are implemented in whole or in part in the Novell® network, proxy server products, email products, operating system products, and/or directory services products distributed by Novell®, Inc., of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

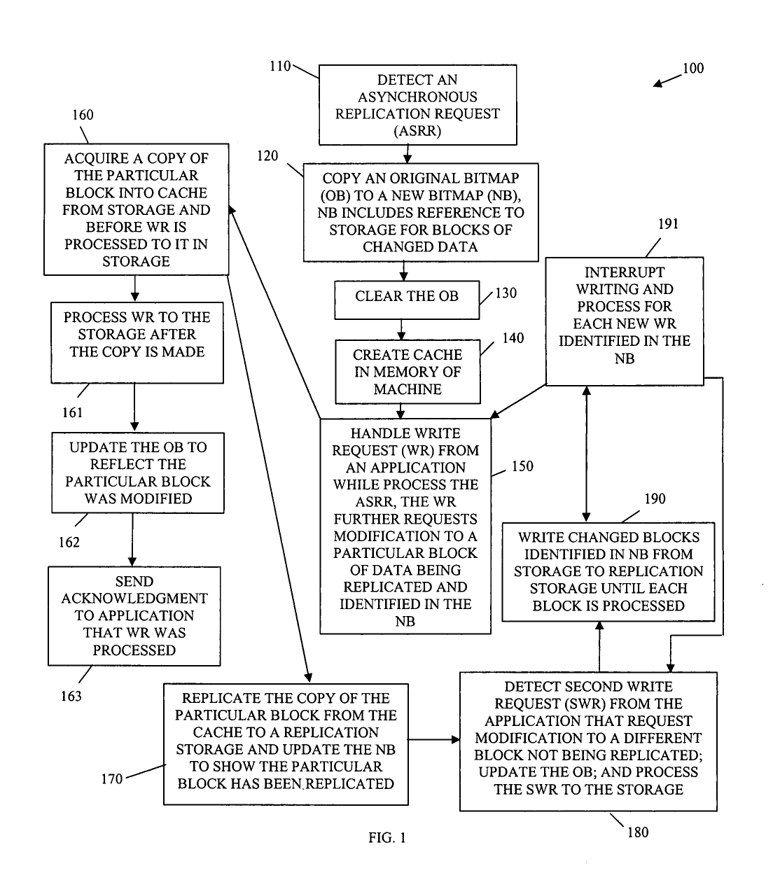

FIG. 1 is a diagram of a method 100 for asynchronous data replication, according to an example embodiment. The method 100 (hereinafter “replication service”) is implemented in a machine-accessible and readable medium. The replication service is operational over and processes within a network. The network may be wired, wireless, or a combination of wired and wireless. The service may be implemented as instructions that when accessed by a machine performs the processing depicted in FIG. 1.

Initially, the replication service processes at configurable periods or intervals that may be referred to as asynchronous replication intervals. The replication service is invoked and processes at the start or end of each asynchronous replication interval. The purpose of processing, as will be discussed in more detail below, is to perform an asynchronous replication from storage or a source to a replica.

At 110, the replication service detects an asynchronous replication request. Again, this detection may occur or be noted at the start or end (depending upon the perspective) of an asynchronous replication request. In other cases, the detection may be the result of an event being raised or a specific request being sent to the replication service. In fact any mechanism to inform the replication service that an asynchronous replication request is needed for processing an asynchronous replication may be used.

At 120, the replication service copies an original bitmap to a new bitmap. The original bitmap includes a bit for each block of data in the storage or source. In between replication periods or intervals, these bits are set as blocks are changed. The new bitmap is a copied over in response to the asynchronous replication requested being detected and it provides a state of the source or storage as of the time that the asynchronous replication request was detected. Each set bit in the new bitmap references particular blocks that changed since the last replication in the storage or source. Unset bits in the new bitmap do not have to be processed to the replica because those blocks, which the unset bits reference in the storage, are unchanged from the last replication that may have took place; assuming the present asynchronous request is not a first replication in which case all the bits will be set in the bitmap.

At 130, the replication service clears or unsets each of the bits in the original bitmap. Once the original bitmap is copied to the new bitmap, the replication service clears out the original bitmap so that it can continue to record and note changes occurring in blocks within the source or storage as the replication service processes a replication in response to detecting the asynchronous replication request.

At 140, the replication service creates a cache in memory of a machine on which it processes. The cache is used to copy selective blocks of data from the storage into the cache where it is then written to the replica, as described in greater detail below.

Once the replication initiates, applications and other services that process in the storage or source environment may continue to process virtually uninterrupted. This means that data is constantly being changed on the storage or source while or during the replication processing and before the replication processing completely finishes. As was described above, this can pose problems for the ongoing replication, which prior techniques have sought to remedy via a snapshot to capture the state of the data at the time an asynchronous replication and subsequent changed blocks are housed in the snapshot. This is an inefficient use of storage space, processing, and requires more I/O.

The replication service solves this problem in a more efficient and different manner than via a snapshot and reduces I/O needed to account for data changes that occur while and during the replication processing.

Specifically, at 150, when a write request is made against the source or storage during processing of the asynchronous replication request, the replication service handles the write request from an issuing application in a novel manner. The write request is identified as being special by determining that a particular block of data from storage or the source that the application is requesting to write to is represented by a set bit in the new bitmap and has not yet being processed from the source to the replica by the replication service. This means that if the write request is permitted to proceed unabated to the source, then when the replication service gets to that block it will produce a replica that does not represent the proper state of the source as of the time of the asynchronous replication request.

The replication solves this by identifying these types of write requests during the processing of the asynchronous replication request and taking additional action to quickly and efficiently permit the application's write request to proceed to the storage or source as soon as is feasible (with minimal or no noticeable or discernable delay) and at the same time preserve the asynchronous replication.

To do this, at 160, the replication service acquires a copy of the particular block that is being requested to make a data change by the pending write request into the cache. The particular block is copied from storage and to the cache before the pending write request processes; this ensures that the proper replication state of the data is retained because the replication service now replicates that block to the replica from the cache and not from the storage. Once a copy is made, the write request may immediately proceed and be processed against the storage.

Thus, at 161, the replication service processes the write request to the storage after the copy is made. At 162, the replication service updates the original bitmap to reflect that the particular block was modified again after replication processing. At 163, the replication service sends an acknowledgment to the application to indicate that the write request was processed. The application now proceeds unabated. The time to copy the block and set the original bitmap is minimal and the application will experience little to no detectable delay in this period of time.

At 170, the replication service also expedites the replication of what is in cache to the replica. This is done by detecting that something is present in the cache and using the block identifier to map it to a set bit in the new bitmap, which is not yet processed. In response, the replication service copies or writes the particular block in the cache to the replica or replication storage and updates the new bitmap to show the particular block has been replicated. The cache entry for the particular block is cleared from the cache.

In other cases, at 180, the replication service detects a second write request from the application that requests modification to a different block not being replicated. Here, the second write request is being made to a different block that is not set or has already been processed and unset from the new bitmap. In such a case, the replication service immediately updates the original bitmap to show a change occurred and permits the second write request to process to the source or storage.

At 190, the replication service iterates the new bitmap and writes changed blocks identified in the new bitmap from storage or the source to the replication storage or replica until each bit that is set or changed block is processed. Again, at 191, processing of the new bitmap to perform the replica may be interrupted when each new write request is identified. The new write request may be for a type identified at 150 or for a type identified at 180.

It is noted that the order of 150-191 can occur in any manner, such that the diagram is presented for purposes of illustration and ease of comprehension and is not intended to limit embodiments to a particular order. In other words, the environment is chaotic and dynamic, such that the new bitmap can be processed first, the special write request, a normal write request, and the subsequent combinations and orders can all vary.

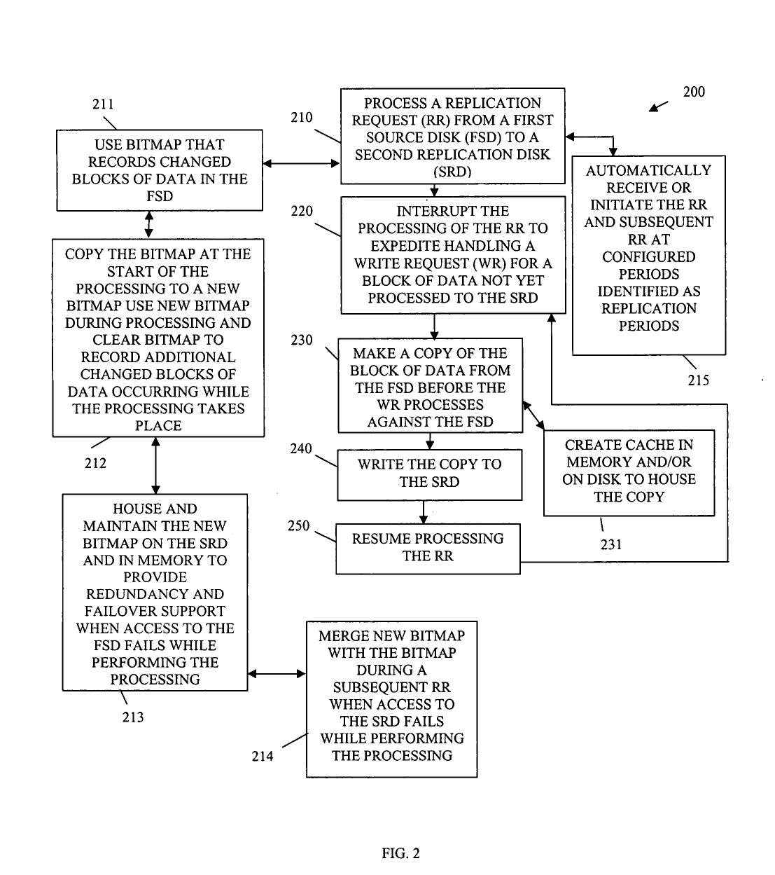

FIG. 2 is a diagram of another method for asynchronous data replication, according to an example embodiment. The method 200 (hereinafter “asynchronous replication service”) is implemented in a machine-accessible and readable medium and is operational over a network. The network may be wired, wireless, or a combination of wired and wireless. The asynchronous replication service is implemented as instructions that when executed by a machine perform the processing depicted in the FIG. 2. The asynchronous replication service provides and alternative and in some cases enhanced perspective of the replication service represented by the method 100 and depicted in the FIG. 1 above.

At 210, the asynchronous replication service processes a replication request from a first source disk to a second source disk. The replication request is associated with an asynchronous replication technique.

To do this, at 211, the asynchronous replication service uses a bitmap that records or notes changes in blocks of data occurring in the first source disk. At 212, a copy of that bitmap is made at the start of processing the replication request. The bitmap is copied to a new bitmap and the asynchronous replication service uses the new bitmap during the processing of the replication. The original bitmap is cleared permitting recordation of additional changed blocks that occur ion the first source disk after the start of the replication request, during the replication request, and after the replication request is finished but before a new replication request is initiated.

At 213, the asynchronous replication service houses and maintains the new bitmap on the second replication disk and/or in memory to provide redundancy and failover support when access to the first source disk fails while performing the processing. So, if the server or machine(s) servicing the first source disk from which the asynchronous replication is occurring fails or the first source disk itself fails, then the new bitmap and its present state is preserved such that when the first source disk becomes available the replication can be picked up and completed properly to the second replication disk.

In another case, at 214, it may be the server or machine associated with the second replication disk or the second replication disk itself fails also. In such as case, the state of the new bitmap can be merged up with the bitmap being managed in the first source disk environment for subsequent replication requests. So, the next replication will be properly synchronized.

In some cases, at 215, the asynchronous replication service automatically receives or initiates the replication request at configured periods, which are identified as replication periods or intervals.

At 220, the asynchronous replication service interrupts the processing of the replication request to expedite the handling of a write request for a block of data that is not yet processed but is to be processed to the second replication disk. At 230, and in such a situation as described immediately above at 220, the asynchronous replication service makes a copy of the block of data from the first source disk before the write request processes against the first source disk.

According to an embodiment, at 231, the asynchronous replication service creates a cache in memory and/or on disk to house the copy.

At 240, the asynchronous replication service writes the copy to the second replication disk, and, at 250, processing resumes for the replication request back at 220. Again, some write requests may be associated with blocks of data on the first source disk that have already been processed to the second replication disk (bit for that block unset or cleared in the new bitmap) or may be associated with blocks of data on the first source disk that were initially unset in the new bitmap. In either case, there is no need to copy such a block, since it is not part of the replication; rather, the original bitmap is set for that block and the write requests processes against the first source disk. The processing for handling and setting the bitmaps was described in greater detail above with reference to the replication service represented by the method 100 of the FIG. 1.

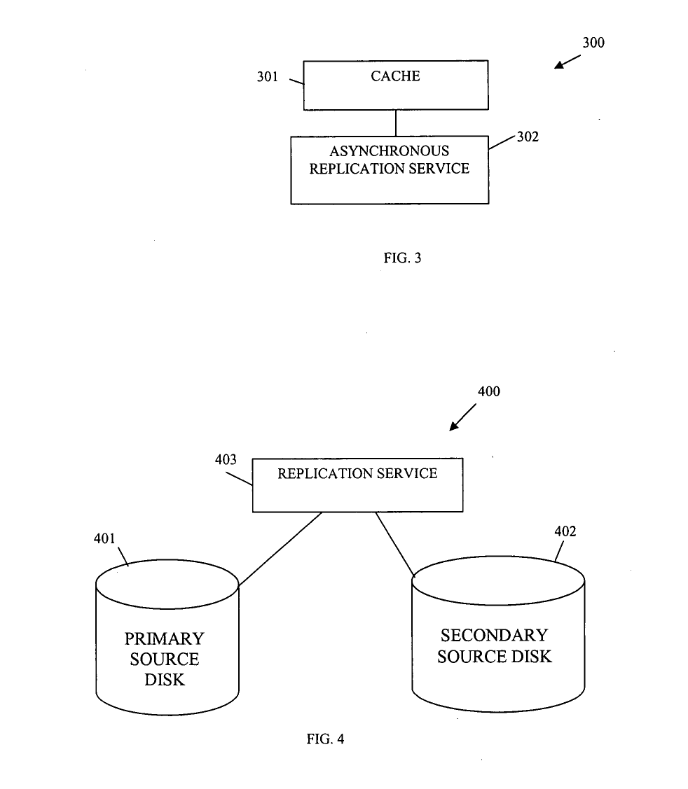

FIG. 3 is a diagram of asynchronous replication system 300, according to an example embodiment. The asynchronous replication system 300 is implemented in a machine-accessible and readable medium and is operational over a network. The network may be wired, wireless, or a combination of wired and wireless. The asynchronous replication system 300 implements, among other things, the processing associated with the replication service represented by the method 100 of the FIG. 1 and the asynchronous replication service represented by the method 200 of the FIG. 2.

The asynchronous replication system 300 includes a cache 301 and an asynchronous replication service 302. Each of these will now be discussed in turn.

The cache 301 is implemented and embodied within a machine and accessible to or within the machine. The cache is for temporarily holding data contents associated with special or particular blocks of data that were identified as being changed for a replication process but have not yet been processed completely in the replication process. In other words, these blocks have changes that were noted at the time a replication process initiated and then more changed that are noted before the replication process has a chance to replicate these blocks from a source disk to a replication disk. The data blocks are copied from the source disk into the cache before pending writes process against or on those blocks.

According to an embodiment, the cache 301 is implemented in memory of the machine and/or in the replication disk. So, there is redundancy with the cache 301. It may also be that the cache 301 is just implemented and managed from the memory or just implemented and managed from the replication disk.

The asynchronous replication service 302 is implemented within and is to process on the machine. The asynchronous replication service 302 uses a bitmap to identify blocks of data that are to be replicated from the source disk to the replication disk during a replication period. The asynchronous replication service 302 expedites and handles replicating the particular blocks noted in the cache 301 to the replication disk during the replication period and when those particular blocks are identified in the bitmap as having pending writes outstanding for the source disk and are also not yet processed to the replication disk (corresponding bit in the bitmap is still set). The expediting is achieved by the asynchronous replication service 302 copying the particular blocks from the source disk to the cache 301 and then flushing the cache 301 to the replication disk. Next, the replication of the particular blocks are noted in the bitmap to show that particular blocks have already been replicated.

In an embodiment, the bitmap is implemented on one or more of the following in memory of the machine and in the replication disk. Again, the bitmap can be implemented in just the memory or on just the replication disk.

The asynchronous replication service 302 creates the bitmap for each new replication period by copying an original bitmap at the start of each replication period and clearing the original bitmap once the copy is produced.

Once the particular blocks are copied from the source disk and to the cache 301, the asynchronous replication service 302 processes the pending writes to the source disk. So, applications producing the pending writes in the source disk environment experience minimal or no real noticeable delay from the time the write is issued until it is processed, since the asynchronous replication service 302 just copies the block to the cache 301 before permitting the pending writes to complete against the source disk.

Example processing associated with the asynchronous replication service 302 were described in detail above with reference to the replication service represented by the method 100 of the FIG. 1 and with reference to the asynchronous relocation service represented by the method 200 of the FIG. 2.

FIG. 4 is a diagram of another asynchronous replication system 400, according to an example embodiment. The asynchronous replication system 400 is implemented in a machine-accessible and readable medium and is accessed and processed over a network. The network may be wired, wireless, or a combination of wired and wireless. The asynchronous replication system 400 implements, among other things, the replication service represented by the method 100 of the FIG. 1; the asynchronous replication service represented by the method 200 of the FIG. 2; and the asynchronous replication system 300 described with reference to the FIG. 3.

The asynchronous replication system 400 includes a primary source disk 401, a secondary replica disk 402, and a replication service 403. Each of these and their interactions with one another will now be discussed in turn.

The primary source disk 401 is the source storage within a source environment that is to be replicated.

The secondary replica disk 402 is target or replica storage that is to house the replicas occurring against the primary source disk 401.

The replication service 403 is implemented in a machine-accessible medium and to process on a machine. Example processing associated with the replication service 403 was presented in detail above with reference to the replication service represented by the method 100 of the FIG. 1 and with reference to the asynchronous replication service represented by the method 200 of the FIG. 2.

The replication service 403 performs asynchronous replication from selective blocks of data on the primary source disk 401 to the secondary replica or replication disk 402. This is done by using a cache to replicate particular ones of the selective blocks of data on the primary source disk 401 to the secondary replica disk 402 when those particular blocks have pending writes that are detected during and while the processing of the asynchronous replication that the replication service 403 is processing.

The selective blocks are identified as blocks that were changed on the primary source disk 401 from a last successful replication. The particular blocks are blocks having pending writes against the primary source disk 401 and are to be processed during a pending and ongoing replication process and are as of yet unprocessed to the secondary replica disk 402. The pending writes occur after the asynchronous replication process begins but before it completes.

According to an embodiment, the cache is implemented in memory of the machine, in storage of the machine, or in both the memory and the storage of the machine.

The replication service 403 is capable of performing asynchronous replication without any assistance of a snapshot associated with the primary source disk 401. This is done via the cache and a bitmap that identifies changed blocks between replication periods or intervals and that is copied at the start of each replication period.

The replication service 403 is to expedite processing associated with the particular blocks by copying the particular blocks to the cache from the primary source disk 401 and then flushing from the cache to the secondary replica disk 402. The replication service 403 notifies an application associated with the pending writes once the particular blocks are copied to the cache from the primary source disk 401 and processed against the primary source disk 401. The cache is then as quickly as feasible flushed to the secondary replica disk 402. In this manner, the cache is manageable and does not become overly large and the applications experience little to no delay.

One now appreciates how asynchronous replication can be achieved in a more storage, I/O, and processor efficient manner and without snapshots.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
detecting an asynchronous replication request;
copying an original bitmap to a new bitmap, wherein the new bitmap identifies changes made to blocks of data since a last successful replication, and wherein the new bitmap includes a reference to storage having the blocks of data changed;
clearing the original bitmap;
creating an a cache in memory of a machine;
handling a write request from an application while processing the asynchronous replication request, wherein the write request further requests modification to a particular block of data being replicated and identified in the new bitmap;
acquiring a copy of the particular block into the cache from the storage and before the write request is processed on it in the storage; and
replicating the copy of the particular block from the cache to a replication storage and updating the new bitmap to show the particular block has been replicated.

2. The method of claim 1 further comprising:
detecting a second write request from the application while processing the asynchronous replication request, wherein the second write request further requests modification to a different block of data that is not being replicated from the new bitmap;
updating the original bitmap to indicate the different block of data has changed since the asynchronous replication request was made; and
processing the second write request to the storage.

3. The method of claim 1 further comprising, processing the write request for the particular block to the storage after the copy is made to the cache.

4. The method of claim 3 further comprising, updating the original bitmap to reflect that the particular block was modified after the asynchronous replication request was detected and before the write request was processed.

5. The method of claim 4 further comprising, sending an acknowledgment to the application indicating that the write request was processed.

6. The method of claim 1 further comprising, writing changed blocks identified in the new bitmap from the storage to the replication storage until each changed block has been written from the storage to the replication storage.

7. The method of claim 6 further comprising, interrupting the writing and performing the processing associated with the handling, acquiring, and replicating for each new write request received when each of the new write requests is identified in the new bitmap and has not yet been written from the storage to the replication storage.

8. A method, comprising:
processing a replication request from a first source disk to a second replication disk;
interrupting the processing of the replication request to expedite the handling of a write request that is associated with a block of data and which is to be processed as part of the replication request but is as yet unprocessed to the second replication disk;
making a copy of the block of data from the first source disk before the write request processes against the first source disk;
writing the copy to the second replication disk; and
resuming the processing of the replication request.

9. The method of claim 8, wherein processing further includes using a bitmap that has recorded changed blocks of data in the first source disk, changed blocks of data are to be acquired from the first source disk and written to the second replication disk.

10. The method of claim 9, wherein processing further includes copying the bitmap at a start of the processing to a new bitmap, using the new bitmap during the processing, and clearing the bitmap to record additional changed blocks of data that occur while the processing takes place.

11. The method of claim 9, wherein processing further includes housing and maintaining the new bitmap on the second replication disk and in memory to provide redundancy and failover support when access to the first source disk fails while performing the processing.

12. The method of claim 11 further comprising, merging the new bitmap with the bitmap during a subsequent replication request when access to the second replication disk fails while performing the processing.

13. The method of claim 8, wherein processing further includes automatically receiving or initiating the replication request and subsequent replication requests at configured periods identified as replication periods.

14. The method of claim 8, wherein making further includes creating a cache in memory and/or on disk to house the copy.

15. A system, comprising:
a cache embodied within a machine readable medium and accessible to or within a machine; and
an asynchronous replication service implemented within and to process on the machine, wherein the asynchronous replication service is to use a bitmap to identify blocks of data that are to be replicated from a source disk to a replication disk during a replication period, and wherein the asynchronous replication service is to expedite and handle replicating particular blocks of data from the source disk to the replication disk during the replication period when those particular blocks are identified in the bitmap and have pending writes outstanding for the source disk, and wherein the asynchronous replication service is to expedite by copying the particular blocks of data from the source disk to the cache and flushing from the cache to the replication disk and then noting in the bitmap that replication for the particular blocks has already occurred.

16. The system of claim 15, wherein the cache is implemented on one or more of the following in memory of the machine and in the replication disk.

17. The system of claim 15, wherein the bitmap is implemented on one or more of the following in memory of the machine and in the replication disk.

18. The system of claim 15, wherein the asynchronous replication service is to create the bitmap as a copy of an original bitmap and is to clear the original bitmap once the copy is produced.

19. The system of claim 15, wherein the asynchronous replication service is to process the pending writes to the source disk after the particular blocks have been copied to the cache.

20. A system, comprising:
a primary source disk;
a secondary replica disk; and
a replication service implemented in a machine-accessible medium and to process on a machine, wherein the replication service is to perform asynchronous replication from selective blocks of data on the primary source disk to the secondary replica disk by using a cache to replicate particular ones of the selective blocks of data on the primary source disk to the secondary replica disk when those particular blocks have pending writes that are detected during the processing of the asynchronous replication.

21. The system of claim 20, wherein the cache is implemented in memory of the machine, in storage of the machine, or in both the memory and the storage of the machine.

22. The system of claim 20, wherein the replication service is to process the asynchronous replication without the assistance of a snapshot associated with the primary source disk.

23. The system of claim 20, wherein the replication service is to expedite processing associated with the particular blocks by copying the particular blocks to the cache and flushing from the cache to the secondary replica disk.

24. The system of claim 21, wherein the replication service is to notify an application associated with the pending writes once the particular blocks are copied to the cache and processed to the primary source disk.
